(19) United States
(12) Patent Application Publication
(10) Pub. No.: US 2004/0015576 A1
(43) Pub. Date: Jan. 22, 2004

(54) Localization of electrical device interfaces

(76) Inventors: Mark David Whaley, Boise, ID (US); Angela Erin Davis, Auburn, CA (US); Brett Alan Green, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/198,853

(22) Filed: Jul. 19, 2002

(51) Int. Cl. G06F 15/173

(52) U.S. Cl. 709/223

(57) ABSTRACT

Localization of electrical device interfaces is disclosed. In one embodiment, a method is provided that comprises storing an embedded server in a location other than within the electrical device, and using the embedded server to present an interface for the electrical device to a user browser. In another embodiment, a system for supporting a browser-accessible interface for an electrical device is provided that comprises a computing device including a processing device and a memory, the memory including an embedded server that is configured to serve content pertinent to at least one of a status and a setting of the electrical device, and an electrical device including a memory that includes a reporting module that is configured to provide dynamic information about the electrical device to the embedded server of the computing device.

### FIELD OF THE INVENTION

The present disclosure relates to localization of electrical device interfaces.

### BACKGROUND OF THE INVENTION

Many electrical devices designed for use with a host device such as a personal computer (PC) now have embedded servers that allow users to control the operation of the electrical devices. For instance, several printing devices include embedded servers with which the various settings of the device can be adjusted and/or viewed. With such an embedded server, users can access a user interface for the device using a conventional browser either via a network connection or through a direct connection.

The ability to access a user interface via a browser provides several advantages. For example, the user can control the settings and operation of the electrical device remotely without having to physically approach and interact with the electrical device. In addition, ease of use is increased in that the user interface accessed with the browser can be more detailed than any user interface that is presented by most electrical devices due to space limitations.

Despite the advantages that can be achieved through use of a browser-accessible interface, the provision of such an interface is not always possible, particularly with relatively inexpensive electrical devices. Specifically, many such devices have limited resources in terms of memory and computing power and therefore may not be capable of supporting a full-fledged browser-accessible interface. To cite one example, many browser-accessible interfaces comprise a plurality of different data strings that permit interface pages to be presented to users in a variety of different languages. As is known in the art, the language of such a page can be changed by simply replacing the various data strings with strings in a different language.

Where such an interface cannot be supported by the electrical device, a more conventional interface, for instance a liquid crystal display (LCD) provided on the electrical device, may instead need to be accessed by the user to change the settings and/or determine the status of the electrical device. This mode of operation can be disadvantageous, especially as users become more familiar with, and dependent upon, browser-accessible interfaces that are provided by more expensive electrical devices, which may be manufactured by the same producer.

Although the limitations of relatively inexpensive electrical devices can be removed by providing for greater memory capacity and/or computing power within the electrical devices, the cost associated with such an endeavor would increase the price of the electrical devices beyond what many customers are willing to pay.

From the above, it can be appreciated that it would be desirable to provide a browser-accessible interface for electrical devices that may have limited storage or computing capacity.

### SUMMARY OF THE INVENTION

The present disclosure relates to localization of electrical device interfaces. In one embodiment, a method is provided that comprises storing an embedded server in a location other than within the electrical device, and using the embedded server to present an interface for the electrical device to a user browser. In another embodiment, the method comprises storing a reporting module within memory of the electrical device, and using the reporting module to provide dynamic information about one of a status and a setting of the electrical device to a remotely-located server used to present the browser-accessible interface to a user.

In another embodiment, a system is provided that comprises a computing device including a processing device and a memory, the memory including an embedded server that is configured to serve content pertinent to one of a status and a setting of the electrical device, and an electrical device including a memory that includes a reporting module that is configured to provide dynamic information about the electrical device to the embedded server of the computing device.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a schematic view of an embodiment of a system through which electrical device interface localization can be obtained.

FIG. 2 is a block diagram of an embodiment of a computing device shown in FIG. 1.

FIG. 3 is a block diagram of an embodiment of an electrical device shown in FIG. 1.

FIG. 4 is a flow diagram that illustrates an embodiment of general operation of the system shown in FIG. 1 in providing a localized electrical device interface.

FIG. 5 is a flow diagram that illustrates an embodiment of operation of an embedded server of the computing device shown in FIG. 2.

FIG. 6 is a flow diagram that illustrates an embodiment of operation of a status/settings reporting module of the electrical device shown in FIG. 3.

FIG. 7 is an embodiment of an information file transmitted to the computing device shown in FIG. 2 from the reporting module of the electrical device shown in FIG. 3.

FIG. 8 is a schematic view of a first example embodiment of an electrical device interface, as viewed in a browser window.

FIG. 9 is a schematic view of a second example embodiment of an electrical device interface.

### DETAILED DESCRIPTION

Disclosed herein are systems and methods through which electrical device interfaces can be localized such that all or a part of the code required to generate a browser-accessible interface can be stored at a location other than within the electrical device itself. To facilitate description of the invention, example systems are first discussed with reference to the figures. Although these systems are described in detail, it will be appreciated that these systems are provided for purposes of illustration only and that various modifications are feasible. After the example systems have been described, examples of operation of the systems are provided to explain the manners in which interface localization can be achieved.

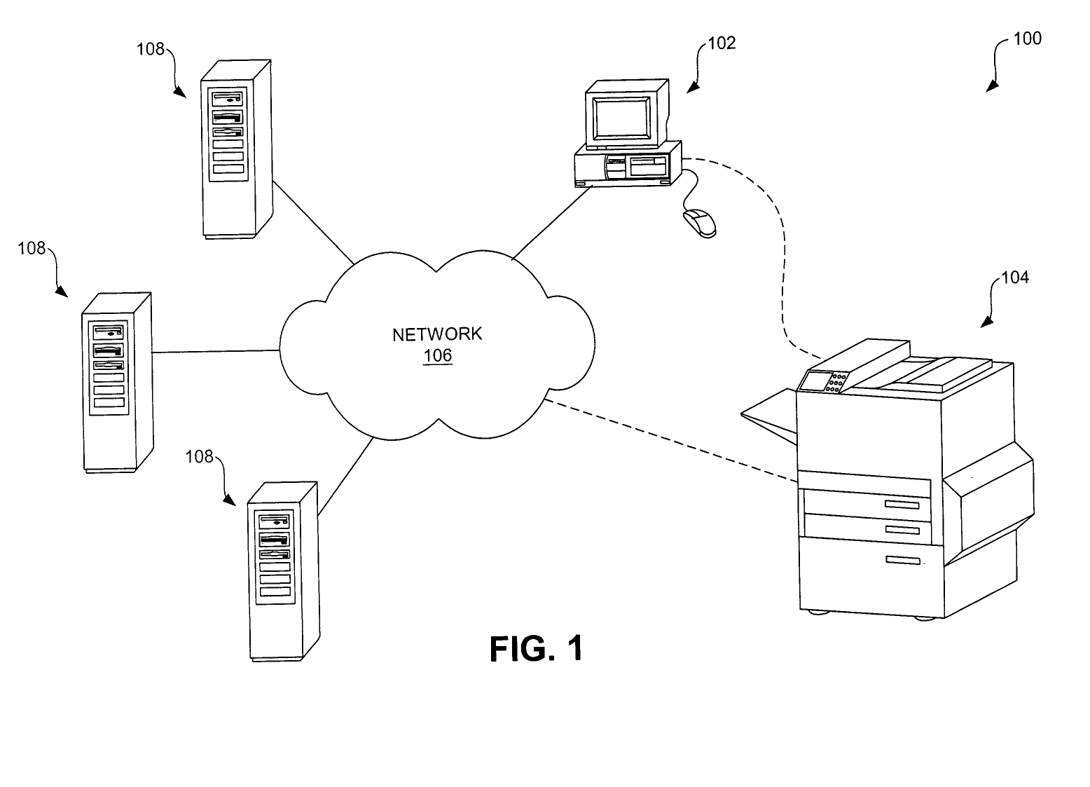

Referring now in more detail to FIG. 1, illustrated is an example system 100 with which an electrical device interface can be localized. As indicated in this figure, the system 100 generally comprises a host computing device 102 and an electrical device 104. As shown in FIG. 1, the host computing device 102 can, for instance, comprise a desktop personal computer (PC). However, it is to be understood that the computing device 102 can comprise substantially any device that can be used to access and/or control the electrical device 104. Therefore, the computing device 102 could, alternatively, comprise a laptop computer, personal digital assistant (PDA), mobile telephone, etc. For the purposes of this disclosure, the term “electrical device” is used to denote any device that manipulates data and which can be accessed via the host computing device 102. By way of example, the electrical device 104 comprises a peripheral device or stand-alone appliance that is capable of generating hardcopy documents, for instance, a printer, multifunction peripheral (MFP) (sometimes referred to as an “all-in-one”), or other such printing device. Persons having ordinary skill in the art will appreciate, however, that this disclosure applies to other types of electrical devices.

As is further identified in FIG. 1, the computing device 102 and the electrical device 104 can be connected to a network 106. The network 106 typically comprises one or more sub-networks that are communicatively coupled to each other. By way of example, these networks can include one or more local area networks (LANs) and/or wide area networks (WANs). Indeed, in some embodiments, the network 106 may comprise a set of networks that forms part of the Internet. In addition, or in exception, the computing device 102 and the electrical device 104 can be directly connected to each other. Such an arrangement is likely in a home or small office environment in which the user does not have access to a network. In such a scenario, communication can be facilitated with a direct electrical and/or optical connection (e.g., parallel port or universal serial bus (USB)), or through wireless communication (e.g., radio frequency (RF) or infrared (IR)).

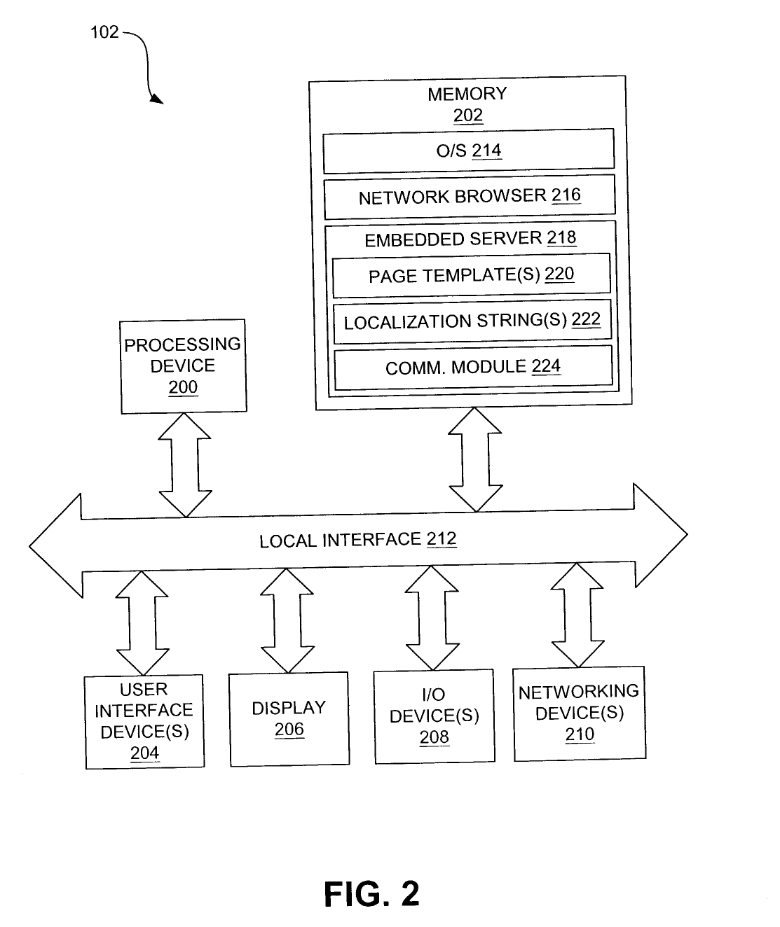

Also shown connected to the network 106 in FIG. 1 are other computing devices 108 that, for instance, comprise server computers. Example configurations for the computing devices 108 are described along with those described for the host computing device 102 in relation to FIG. 2.

FIG. 2 is a block diagram illustrating an example architecture for the computing devices 102, 108 shown in FIG. 1. As indicated in FIG. 2, each computing device 102, 108 can comprise a processing device 200, memory 202, one or more user interface devices 204, a display 206, one or more I/O devices 208, and one or more networking devices 210, each of which is connected to a local interface 212. The processing device 200 can include any custom made or commercially available processor, a central processing unit (CPU) or an auxiliary processor among several processors associated with the computing device 102, a semiconductor based microprocessor (in the form of a microchip), or a macroprocessor. The memory 202 can include any one of a combination of volatile memory elements (e.g., random access memory (RAM, such as DRAM, SRAM, etc.)) and nonvolatile memory elements (e.g., ROM, hard drive, tape, CDROM, etc.).

The one or more user interface devices 204 comprise those components with which the user can interact with the computing device 102. Where the computing devices comprise PCs or similar devices, these components can comprise those typically used in conjunction with a PC such as a keyboard and mouse. Where the computing devices comprise a handheld device such as a PDA or mobile telephone, the user interface devices 204 can comprise one or more function buttons or keys. The display 206 can comprise a display typically used in conjunction with a PC such as a computer monitor or liquid crystal display (LCD) screen. Where the computing devices comprise a handheld device, the display 206 can comprise a LCD that may or may not be touch-sensitive.

The one or more I/O devices 208 comprise components used to facilitate connection of the computing devices to other devices directly, such as the electrical device 104. Therefore, these devices can, for instance, comprise one or more serial, parallel, small system interface (SCSI), universal serial bus (USB), IEEE 1394 (e.g., Firewire™), or personal area network (PAN) connection devices. The networking devices 210 comprise the various components used to transmit and/or receive data over the network 106. By way of example, the networking devices 210 include a device that can communicate both inputs and outputs, for instance, a modulator/demodulator (e.g., modem), an RF or IR transceiver, a telephonic interface, a bridge, a router, as well as a network card, etc.

The memory 202 normally comprises various software programs including an operating system (O/S) 214 and a network browser 216. The O/S 214 controls the execution of other software and provides scheduling, input-output control, file and data management, memory management, and communication control and related services. The browser 216 comprises the software that is used to browse data over the network 106 or other data served by a localized source of information. The browser 216 can, for example, comprise a currently available Internet browser such as Microsoft Internet Explorer™ or Netscape Navigator™.

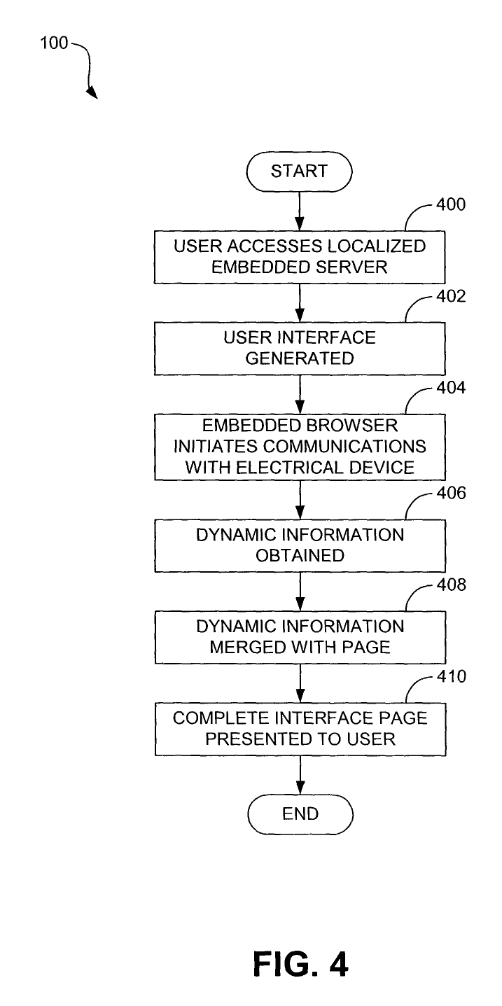

In addition to the O/S 214 and the browser 216, the memory 202 can include an embedded server 218 that is used to serve portions of the content that form the browser-accessible interface of the electrical device 104. As is described in greater detail below, the embedded server 218 can comprise one or more interface page templates 220, one or more sets of localization strings 222, and a communication module 224 that is configured to communicate with the electrical device 104, either directly or via the network 106, so as to obtain dynamic information from the electrical device. Operation of the embedded server 218 is described with reference to FIG. 4 below.

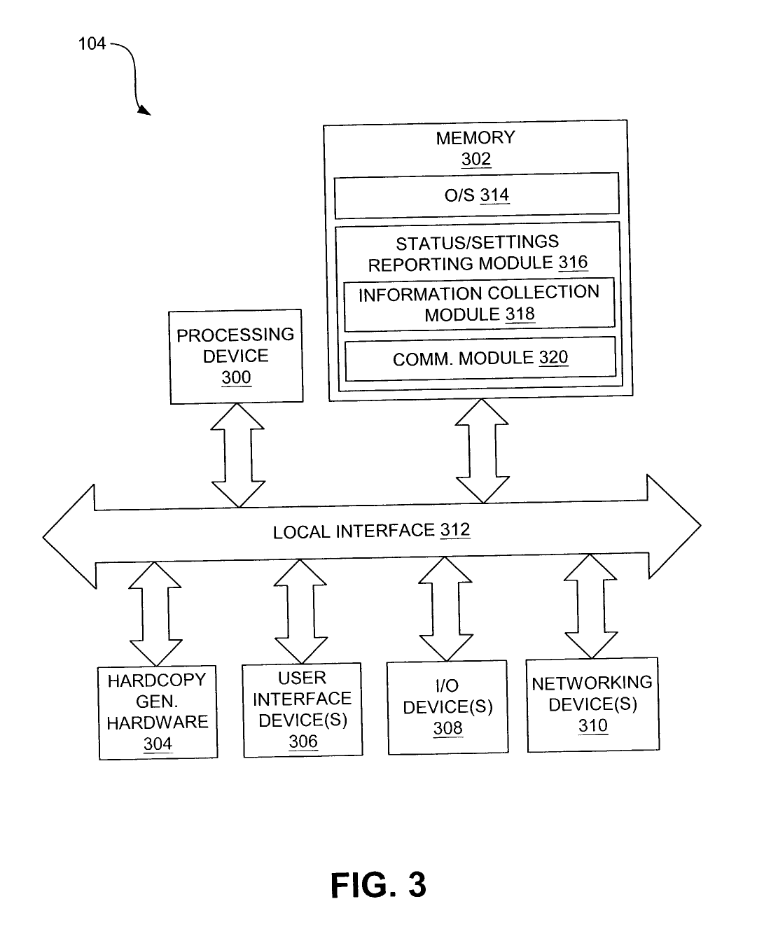

FIG. 3 is a block diagram illustrating an example architecture for the electrical device 104 shown in FIG. 1. As indicated in FIG. 3, the electrical device 104 can comprise a processing device 300, memory 302, hardcopy generation hardware 304, one or more user interface devices 306, one or more I/O devices 308, and one or more networking devices 310. Each of these components is connected to a local interface 312 that, by way of example, comprises one or more internal buses. The processing device 300 is adapted to execute commands stored in memory 302 and can comprise a general-purpose processor, a microprocessor, one or more application-specific integrated circuits (ASICs), a plurality of suitably configured digital logic gates, and other well known electrical configurations comprised of discrete elements both individually and in various combinations to coordinate the overall operation of the electrical device 104.

The hardcopy generation hardware 304 comprises the components with which the electrical device 104 can create hardcopy documents. Accordingly, this hardware 304 can comprise, for instance, a paper drive mechanism, print engine, fusing system, etc. As will be appreciated by persons having ordinary skill in the art, where the electrical device 104 is not configured as a printing device, the electrical device may not comprise the above-described hardcopy generation hardware 304 but may, instead, comprise alternative hardware that is configured to complete a functionality for which the electrical device is intended.

The one or more user interface devices 306 typically comprise minimal interface tools with which the device settings can be changed and through which the user can communicate commands to the electrical device 104. By way of example, the user interface devices 306 comprise one or more function keys and/or buttons with which the operation of the electrical device 104 can be controlled, and a display, such as a small LCD, with which some information can be visually communicated to the user. The I/O devices 308 and networking devices 310 can have configurations similar to like-named components identified above with reference to FIG. 2.

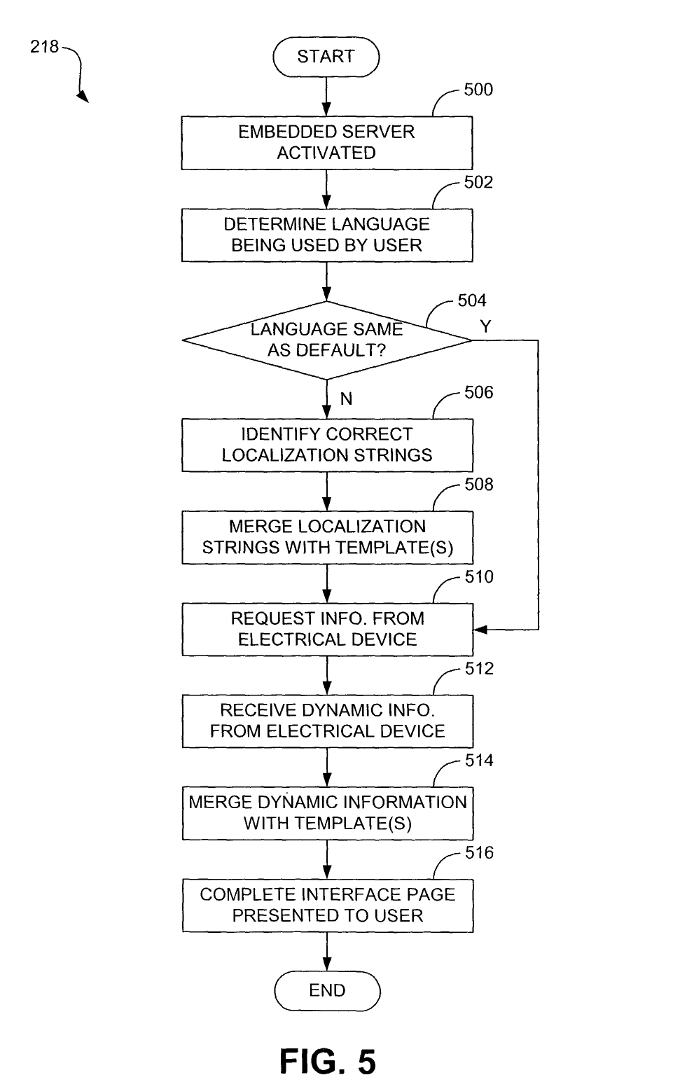

The memory 302 includes various software (e.g., firmware) programs including an operating system 314 that contains the various commands used to control the general operation of the electrical device 104. In addition, the memory 302 can include a status/settings reporting module 316 that comprises an information collection module 318 that collects various dynamic information about the status and/or settings of the electrical device 104, and a communication module 320 that is used to transmit the collected information to the computing device 102, 108. Operation of the status/settings reporting module 316 is described with respect to FIG. 5 below.

Various software and/or firmware programs have been described herein. It is to be understood that these programs can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

Example systems having been described above, system operation will now be discussed. In the discussions that follow, flow diagrams are provided. It is to be understood that any process steps or blocks in these flow diagrams may represent modules, segments, or portions of code that include one or more executable instructions for implementing specific logical functions or steps in the process. It will be appreciated that, although particular example process steps are described, alternative implementations are feasible. Moreover, steps may be executed out of order from that shown or discussed, including substantially concurrently or in reverse order, depending on the functionality involved.

As noted above, the system 100 can be used to facilitate localization of the electrical device interface so that less storage and/or computing capacity is required of the electrical device. This result is accomplished by utilizing the resources of a computing device, which typically has far greater storage and computing capacity than most electrical devices. In particular, the embedded server (i.e., code) that is normally stored within memory of the electrical device is instead stored within a computing device, whether it be the host computing device (e.g., computing device 102, FIG. 1) or a network-accessible computing device (e.g., a computing device 108, FIG. 1). In the latter case, the computing device may comprise a server computer that is accessible to various users connected to a LAN. With this functionality, the storage and/or computing capacity of the electrical device can be minimized to thereby minimize its cost.

FIG. 4 illustrates a high-level example of operation of the system 100 in providing localized interface generation. Beginning with block 400 of this figure, the user accesses the localized embedded server 218 that is stored within his or her computing device 102 or stored within a network-accessible computing device 108. Once the embedded server 218 is accessed, a user interface page is generated by the server, as indicated in block 402. The page can be generated by the server 218 with reference to one or more of the page templates 220 stored within the server and, where necessary, one or more localization strings 222 that are used to modify the content of the template(s). Before the page is presented to the user in the user browser 216, the embedded server 218 initiates communications with the electrical device 104, as indicated in block 404. Through these communications, dynamic information relevant to the status and/or settings of the electrical device 104 is obtained, as indicated in block 406.

Once this dynamic information is obtained, it is merged by the embedded server 218 with the content of the page generated above (block 402), as indicated in block 408, and the complete interface page is presented to the user in the user's browser 216, as indicated in block 410. With this flow, accessing of the electrical device interface is seamless to the user. In fact, the user may not even be aware that the server 218 is not stored within the electrical device 104. Accordingly, even if the electrical device 104 is a relatively inexpensive electrical device having limited resources, interaction with the electrical device will have the same “feel” as interaction with more expensive electrical devices that comprise embedded servers that support a full-fledged, browser-accessible interface.

FIG. 5 provides an example of operation of the embedded server 218. Beginning with block 500 of this figure, the embedded server 218 is first activated. This activation occurs, for instance, when the user enters the address (e.g., universal resource locator (URL)) of the embedded server 218. Once the embedded server 218 is activated, the server determines the language that is being used by the browser, as indicated in block 502. This determination can be made with reference to information contained in the request made by the browser to the embedded server 218. After the language being used is determined, the embedded server 218 can determine whether this language is the same language as that used by default in the interface page template(s) 220, as indicated in decision element 504. If it is the same language (e.g., English), flow continues down to block 510 described below. If, on the other hand, the language being used is different from that contained in the template(s) 220, flow continues to block 506 at which the server 218 identifies the correct localization strings 222 that are implicated (and which comprise content in the different language) and, as indicated in block 508, merges these strings with the template(s) such that the correct language strings will be presented to the user.

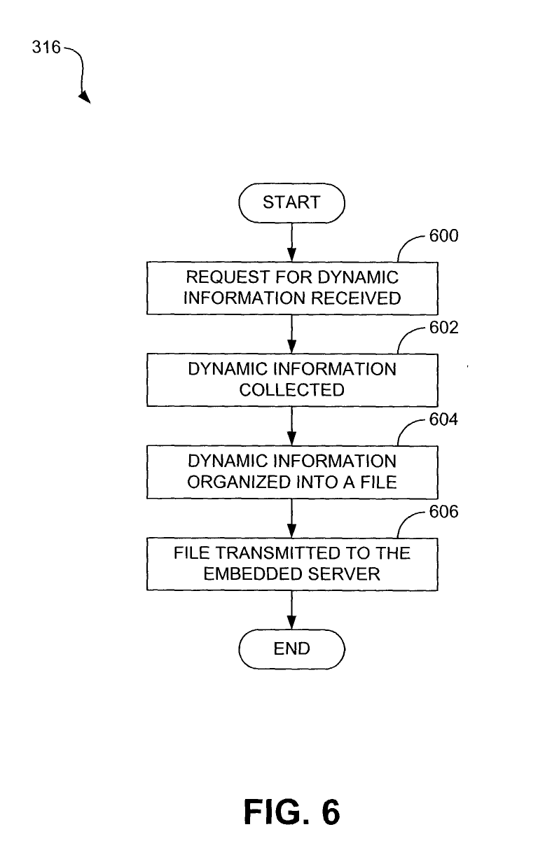

Next, with reference to block 510, the server 218, using the communication module 224, requests status/settings information from the electrical device 104. Referring now to FIG. 6, which illustrates an example of operation of the status/settings reporting module 316 of the electrical device 104, the status/settings reporting module 316 of the electrical device receives the request from the embedded server 218, as indicated in block 600. Information concerning the electrical device status (e.g., ready, paper jam, toner levels, recording media status, etc.) and the electrical device settings (e.g., contrast settings, simplex/duplex settings, etc.) are collected by the collection module 318, as indicated in block 602. In that this information can change or can be changed by the user, this information is dynamic.

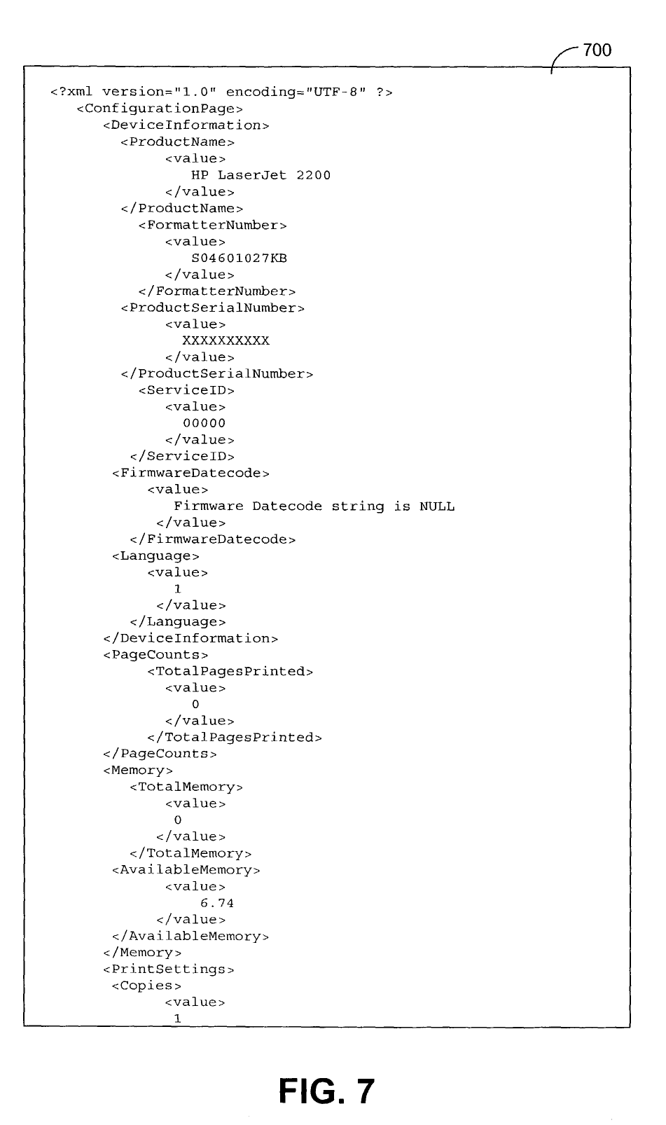

Once the various information is collected, it can be organized into a file, as indicated in block 604. By way of example, the various dynamic information can be organized into an XML file 700 such as that illustrated in FIG. 7. As shown in this figure, the XML file can comprise a variety of values 702 pertinent to various different electrical device components and/or settings. After the dynamic information has been organized into a file, the file can be transmitted to the embedded server 218 of the computing device 102, 108, as indicated in block 606, using the communication module 320 of the reporting module 316.

With reference back to FIG. 5 and block 512, the embedded server 218 receives the dynamic information file from the electrical device 104. After this file is received, it can be analyzed and merged with the template(s) 220, as indicated in block 514. Once this information is merged, a complete interface page can be presented to the user, as indicated in block 516.

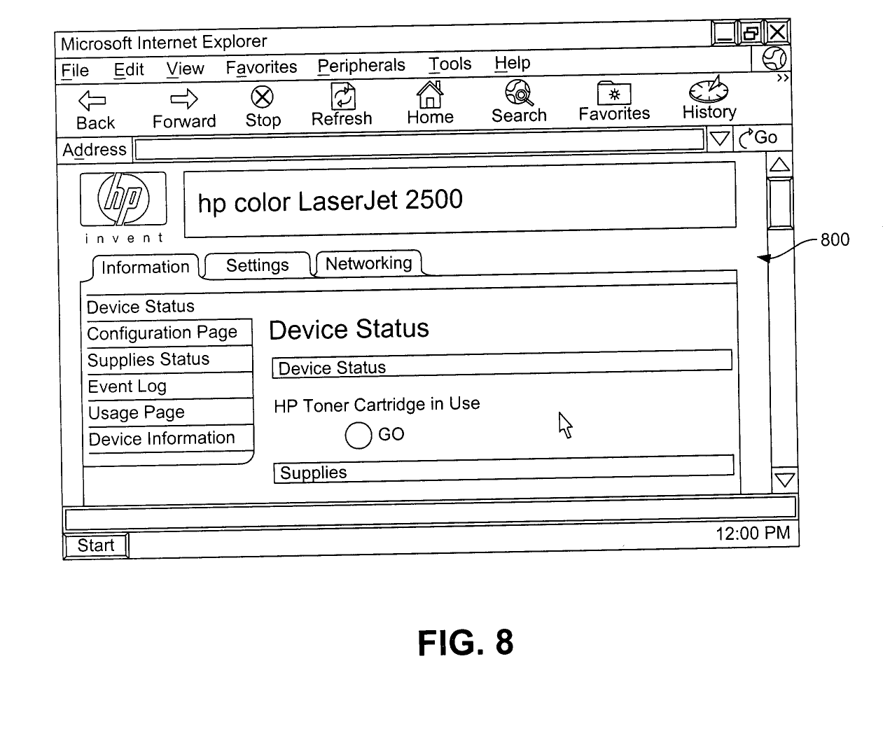

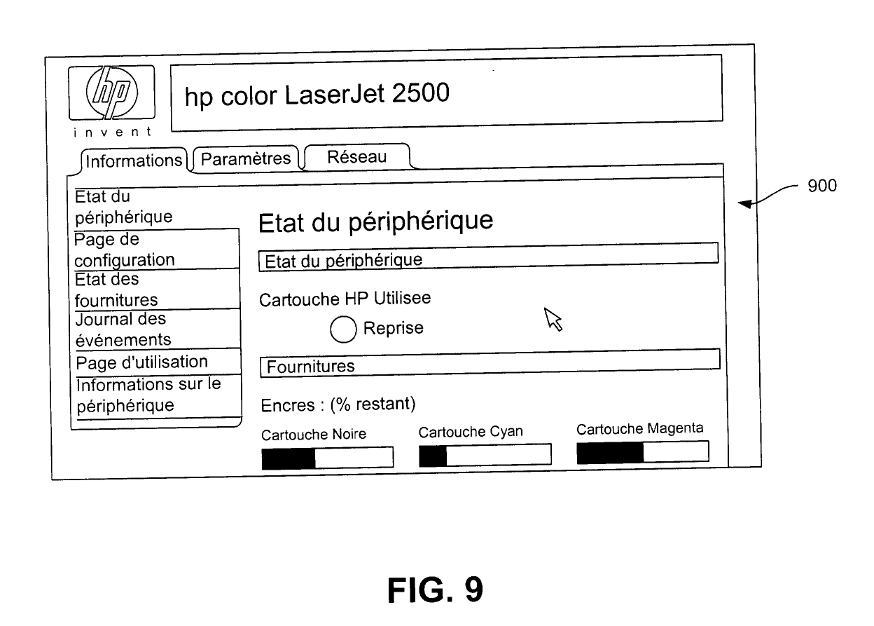

With the flow described above, the user can be presented with a full-fledged, browser-accessible electrical device interface. Where the language used by the user matches that of the template, one or more interface pages can be presented to the user in the default language. For example, if a template is written in English, an interface page, such as interface page 800 shown in FIG. 8, can be presented to the user. Where the language used by the user is different from that of the template, the various English strings can be replaced with the other language strings to provide an interface page written in the correct language. For instance, where the other language comprises French, an interface page 900 shown in FIG. 9 can be presented to the user.

While particular embodiments of the invention have been disclosed in detail in the foregoing description and drawings for purposes of example, it will be understood by those skilled in the art that variations and modifications thereof can be made without departing from the scope of the invention as set forth in the following claims.

What is claimed is:

1. A method for supporting a browser-accessible interface for an electrical device, comprising:
storing an embedded server in a location other than within the electrical device; and
using the embedded server to present an interface for the electrical device to a user browser.

2. The method of claim 1, wherein the step of storing an embedded server comprises storing an embedded server in a host computing device of the user.

3. The method of claim 1, wherein the step of storing an embedded server comprises storing an embedded server in a computing device that is network-accessible to a host computing device of the user.

4. The method of claim 1, further comprising obtaining dynamic information from the electrical device concerning at least one of a status and a setting of the electrical device.

5. The method of claim 4, further comprising merging the dynamic information with other content to generate the interface.

6. A method for supporting a browser-accessible interface for an electrical device, comprising:
storing a reporting module within memory of the electrical device; and
using the reporting module to provide dynamic information about at least one of a status and a setting of the electrical device to a remotely-located server used to present the browser-accessible interface to a user.

7. The method of claim 6, wherein the step of using the reporting module to provide dynamic information occurs in response to a request for information received from the server.

8. A system for supporting a browser-accessible interface for an electrical device, comprising:
a computing device including a processing device and a memory, the memory including an embedded server that is configured to serve content pertinent to at least one of a status and a setting of the electrical device; and
an electrical device including a memory that includes a reporting module that is configured to provide dynamic information about the electrical device to the embedded server of the computing device.

9. The system of claim 8, wherein the computing device memory further comprises at least one localization string that is used to modify served content.

10. The system of claim 9, wherein the at least one localization string comprises a different language string.

11. The system of claim 8, wherein the computing device memory further comprises a browser that is used to view the content served by the embedded server.

12. The system of claim 8, wherein the electrical device comprises a printing device.

13. A method for presenting a browser-accessible interface for an electrical device, comprising:
requesting dynamic information regarding at least one of a status and a setting of the electrical device;
receiving the dynamic information from the electrical device;
merging the dynamic information with other content to generate an interface page; and
providing the interface page to a user browser for viewing by a user.

14. The method of claim 13, further comprising determining the language being used by the user and, if that language differs from a default language, replacing content strings with content strings in the language being used by the user.

15. A method for facilitating generation of a browser-accessible interface for an electrical device, comprising:
receiving a request for dynamic information from a remotely-located server; and
providing the requested dynamic information to the remotely-located server so that the server can merge the dynamic information with other content to generate an electrical device interface that can be accessed with a browser.

16. A computing device, comprising:
a processing device; and
memory including an embedded server that is configured to generate an electrical device interface to a user browser, the embedded server including:
a page template used to generate the interface;
at least one localization string that contains content written in a language other than a default language, and
a communication module that is configured to transmit requests for dynamic information to an electrical device for which the interface is being generated.

17. An electrical device, comprising:
a processing device; and
memory including a reporting module that is configured to collect dynamic information regarding a status or a setting of the electrical device and a communication module that is configured to facilitate generation of an interface for the electrical device by transmitting the dynamic information to a remotely-located server that will use the information to generate an electrical device interface.

18. The electrical device of claim 17, wherein the electrical device is a printing device.

19. An embedded server stored on a computer-readable medium that is configured to generate a browser-accessible interface for an electrical device, the server comprising:
logic configured to generate an interface page comprising content relevant to the electrical device;
logic configured to obtain dynamic information regarding at least one of a status and a setting of the electrical device;
logic configured to merge the content relevant to the electrical device with the dynamic information; and
logic configured to present an interface page to a user.

20. The server of claim 19, further comprising logic configured to determine the language used by a user and logic configured to change the language of the content relevant to the electrical device if the language used by the user is different from a default language.

21. An information reporting program stored on a computer-readable medium, comprising:
logic configured to collect dynamic information regarding the status or settings of the electrical device; and
logic configured to facilitate generation of a user interface for an electrical device by communicating the dynamic information to a remotely-located server that will use the information to generate an electrical device interface.
